(19) United States
(12) Patent Application Publication
(10) Pub. No.: US 2012/0040558 A1
(43) Pub. Date: Feb. 16, 2012

(54) ELECTRICAL CONNECTOR PROVIDED WITH A GROUNDING TERMINAL STRUCTURE

(75) Inventors: KUO-CHI LEE, TAIPEI COUNTY (TW); SHIH-CHIA LAI, TAIPEI COUNTY (TW)

(73) Assignee: CONCRAFT HOLDING CO., LTD., GRAND CAYMAN KY1-1208 (KY)

(21) Appl. No.: 12/892,085

(22) Filed: Sep. 28, 2010

(30) Foreign Application Priority Data
Aug. 11, 2010 (TW) 099215374

(51) Int. Cl. H01R 13/648

(52) U.S. Cl. 439/607.01

(57) ABSTRACT

An electrical connector includes an insulated body having a tongue portion with upper and lower surfaces and a front end; a conduction terminal disposed on the upper surface and having a contact section; a grounding terminal disposed on the upper surface, spaced apart from the conduction terminal and having a connection section; and a grounding metal plate attached to the lower surface of the tongue portion in such a manner that the grounding metal plate is integrally formed with the connection section of the grounding terminal proximate to the front end thereof. The contact section of the conduction terminal is also located proximate to the front end of the holding tongue portion.

This application claims the benefits of the Taiwan Patent Application Serial NO. 099215374 filed on Aug. 11, 2010, the subject matter of which is incorporated herein by reference.

### BACKGROUND OF THE INVENTION

1. Field of the Invention

The present invention relates to an electrical connector, more particularly to an electrical connector including a grounding metal plate and a grounding terminal integrally formed with the grounding metal plate.

2. Description of the Prior Art

In order to transmit a great burden of information between the CPU and the display device in a computer set, an electrical connector using low voltage differential signaling serves as signal transmission interface due to its high-speed signal transmission therethrough and due to its noise immunity. Such type of electrical connector is generally known as LVDS connector since it can transmit a tremendously large amount of information within a single time interval and since noise is subtracted away therefrom. In order to protect the interior components and resist the electromagnetic interference, a metal cover member covers the connector from an exterior thereof and a plurality of grounding terminals are soldered to the metal cover member to form a grounding wire such that electrical charge from the metal cover member is guided via the grounding wire to the grounding terminal, hence into the earth.

However, the signal transmission terminals within the prior art LVDS are connected densely and are arranged closely such that it is difficult to conduct soldering or welding process when required. A tin-soldering process is generally carried out to coupled electrically the required terminals and in case of accidentally touching an adjacent terminal during the soldering process, a short circuit may result and leading to inferior quality of the connector. In addition, the tin-soldering process itself causes high expense and time consuming for the manufacturers.

According to the prior art technique, the metal cover member is generally bent, punched or cut out to form a flexible strip section prior to assembly. During assembly of the metal cover member over the insulated body, the flexible strip section is to be coupled electrically with the ground terminal. However, during the assembly, the flexible strip section may possibly be engaged electrically to the other undesired terminal. Thus, short circuits may result within the connector and hence the connector must be discarded.

Moreover, during insertion of the terminals into the insulated body, the entire terminals are held in alignment firstly into a row and then the row of terminals is inserted into the terminal grooves simultaneously at the same time. In the event, even if one terminal is not aligned with the rest of terminals prior to the insertion, there may result in failure of terminal insertion, hence leading to poor quality or discarding of the connector.

### SUMMARY OF THE INVENTION

In order to eliminate or improve the aforesaid drawbacks, the object of the present invention is to provide an electrical connector, which does not require additional connecting structure between the grounding terminals and the grounding metal plate and an insert-molding process is used for fixing an insulated body on the terminals.

The electrical connector according to the present invention is generally called to possess a grounding terminal structure, and includes an insulated body, a conduction terminal, a grounding terminal, and a grounding metal plate. The insulated body includes a holding tongue portion having upper and lower surfaces and a front end thereof. The conduction terminal is disposed on the upper surface of the tongue portion and has a contact section. The grounding terminal is disposed on the upper surface of the tongue portion, is spaced apart from the conduction terminal and has a connection section. The grounding metal plate is disposed below and attached to the lower surface of the tongue portion in such a manner that the grounding metal plate is integrally formed with the connection section of the grounding terminal proximate to the front end of the tongue portion. The contact section of the conduction terminal is also located proximate to the front end of the tongue portion. During the manufacturing, the insulated body is mounted on the conduction and grounding terminals and the grounding metal plate such the latter three are hold securely relative to the insulated body.

As described above, the electrical connector of the present invention is said to possess the grounding terminal structure and therefore does not need other structure for electrically connected to the grounding terminal and the grounding metal plate since the latter two are integrally formed with each other. In other words, there is no need to conduct the soldering process and hence economizing the labor time. In addition, the problem of accidentally touching an adjacent terminal during the tin-soldering process and hence leading a short circuit as encountered in the prior art manufacturing can be avoided. Furthermore, since insert-molding process is used in the present invention for mounting the insulated body relative to the conduction terminal and the grounding terminal, the latter two are stably and securely fixed on to the insulated body after production. Moreover, the need of holding the entire terminals in alignment firstly into a row during insertion of the terminals into the insulated body in the prior art is also avoided. Hence there is no failure of terminal insertion as encountered in the prior art manufacturing process.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 shows a perspective view of an electrical connector of the present invention having a grounding terminal structure;

FIG. 2 is a perspective and exploded view of the electrical connector of the present invention shown in FIG. 1;

FIG. 3 is a perspective and exploded view of the electrical connector of the present invention, wherein the elements shown in FIG. 2 are turned upside down to illustrate lower structures thereof of;

FIG. 4 illustrates a cross-sectional view of a grounding terminal and a grounding metal plate employed in the electrical connector of the present invention prior to assembly;

FIG. 5 illustrates a cross-sectional views of a conduction terminal and the grounding metal plate employed in the electrical connector of the present invention prior to assembly;

FIGS. 6 and 7 shows a top planar view of a relatively large metal plate from which the conduction terminal, the grounding terminal and the grounding metal plate are fabricated during manufacturing process in order to form the electrical connector of the present invention; and

FIG. 8 is top planar view, illustrating a state after partially assembly of some elements during manufacturing to form the electrical connector of the present invention

### DETAILED DESCRIPTION OF THE PREFERRED EMBODIMENT

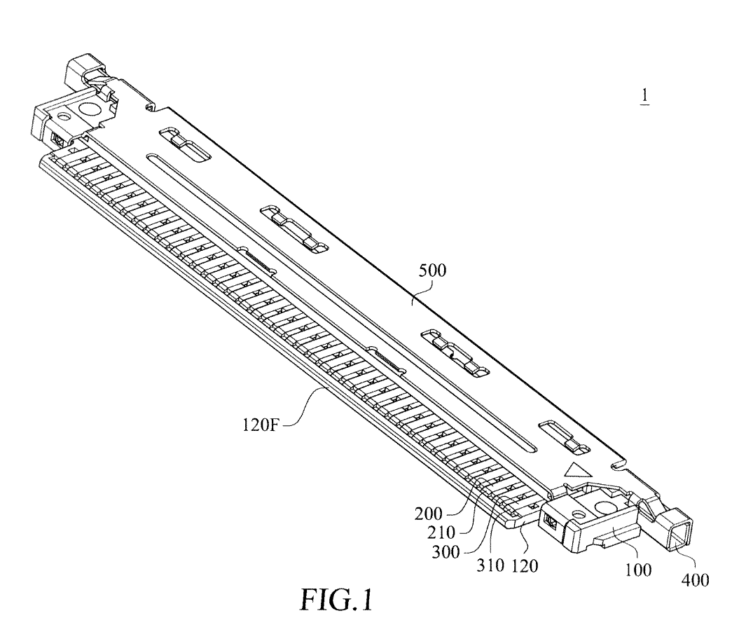

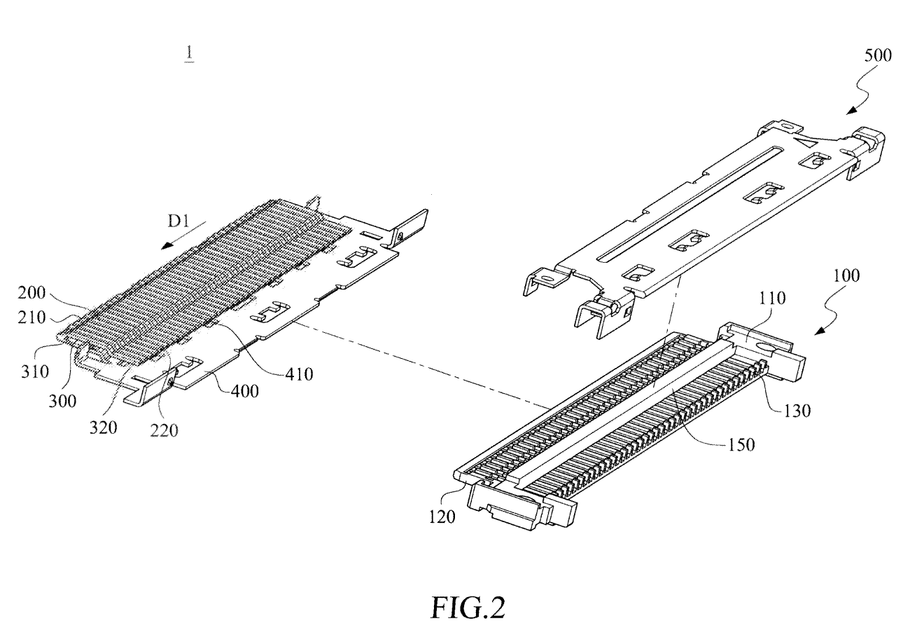

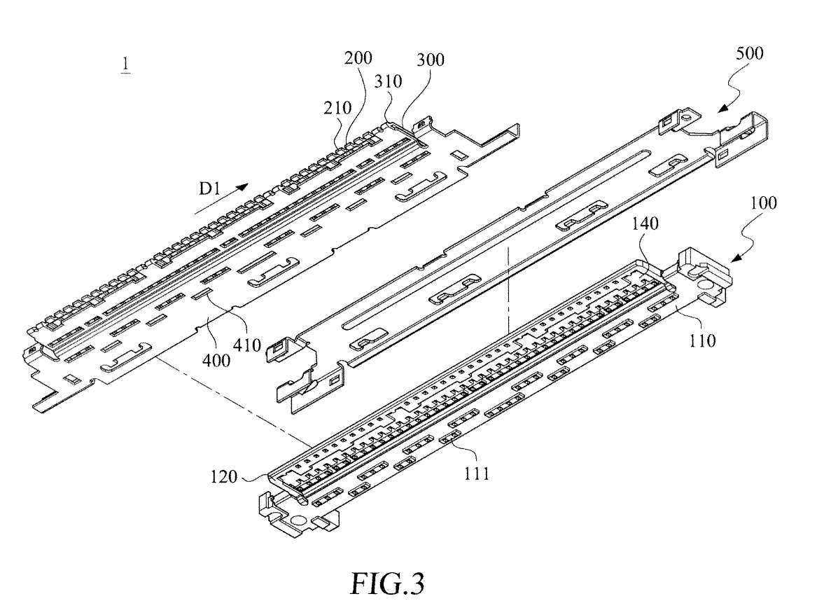

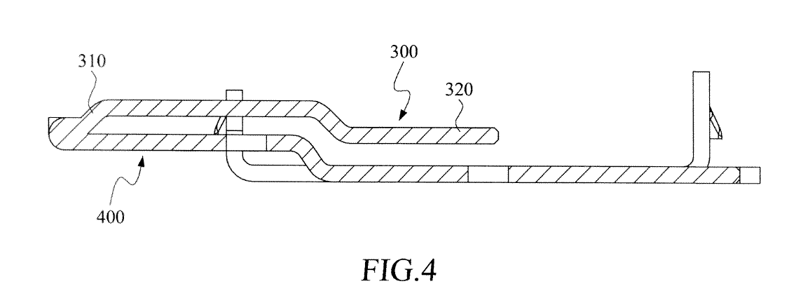

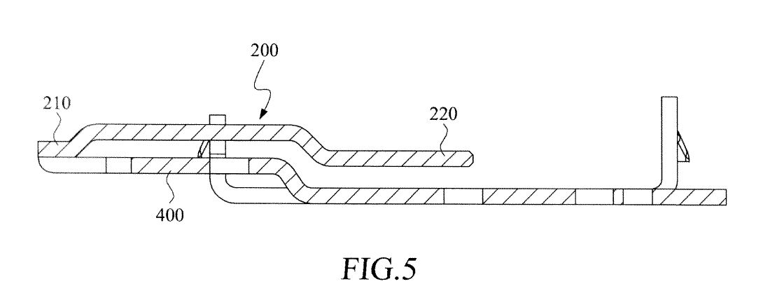

Referring to FIGS. 1 and 5, wherein FIG. 1 shows a perspective view of an electrical connector of the present invention having a grounding terminal structure; FIG. 2 is a perspective and exploded view of the electrical connector of the present invention shown in FIG. 1; FIG. 3 is a perspective and exploded view of the electrical connector of the present invention, wherein the elements shown in FIG. 2 are turned upside down to illustrate lower structures thereof; FIG. 4 illustrates a cross-sectional view of a grounding terminal and a grounding metal plate employed in the electrical connector of the present invention prior to assembly while FIG. 5 illustrates a cross-sectional view of a conduction terminal and the grounding metal plate employed in the electrical connector of the present invention prior to assembly.

Note that the electrical connector 1 of the present invention uses differential signaling for transmitting information in high-speed, is generally known as LVDS (low voltage differential signaling) connector and includes an insulated body 100, a plurality of conduction terminals 200, a plurality of grounding terminals 300, a grounding metal plate 400 and a metal cover member 500.

The insulated body 100 includes a main portion 110, a holding tongue portion 120 and a fixing portion 150. The main portion 110 has a bottom side formed with a plurality of engaging blocks 111 (see FIG. 3). The tongue portion 120 projects frontward from the main portion 110, and has upper and lower surfaces and a front end 120F thereof (see FIG. 1). The fixing portion 150 is disposed above the main portion 110. The upper surface of the tongue portion 120 is formed with a plurality of terminal reception channels 130, which extends through the fixing portion 150. The lower surface of the tongue portion 120 is formed with a grounding chamber 140 in spatial communication with each of the terminal reception channels 130.

The conduction terminals 200 are disposed respectively within the terminal reception channels 130 in the tongue portion 120 and extend through the fixing portion 150, which, in turn, enhances retention of the terminals 200 within the terminal reception channels 130, as best shown in FIG. 5. Each conduction terminal 200 has a contact section 210 and a termination section 220 opposite to the contact section 210. As illustrated in FIG. 5, the contact section 210 of each conduction terminal 200 is slightly spaced apart from the grounding metal plate 400. In other words, the conduction terminals 200 and the grounding metal plate 400 are insulated relative to each other. The contact sections 210 of the conduction terminals 200 are located proximate to the front end 120F of the tongue portion 120 while the termination sections 220 of the conduction terminals 200 are terminating within the main portion 110 of the insulated body 100.

The grounding terminals 300 are also disposed respectively within the terminal reception channels 130 in the tongue portion 120 and extend through the fixing portion 150 in such a manner that an adjacent pair of the conduction terminal 200 and the grounding terminal 300 are arranged on the tongue portion 120 in parallel manner and are spaced apart from each other. In fact, the conduction and grounding terminals 200, 300 are alternately arranged on the tongue portion 120 in parallel manner. Each grounding terminal 300 has a connection section 310 proximate to the front end 120F of the tongue portion 120 and a termination section 320 terminating in the main portion 110 of the insulated body 100. As best shown in FIG. 4, after assembly, the connection sections 310 of the grounding terminals 300 are integrally formed with the grounding metal plate 400 proximate to the front end 120F of the tongue portion 120. In this embodiment, the conduction and grounding terminals 200, 300 may have the same structure while the contact and connection sections 210, 310 of the conduction and grounding terminals 200, 300 are flushed with one another and the termination sections 220. 320 thereof are flushed with one another along a predetermined direction D1.

The grounding metal plate 400 is disposed below and attached to the lower surface of the tongue portion 120 and extends along the predetermined direction D1 in such a manner that a section of the grounding metal plate 400 is engaged within the grounding chamber 140 (see FIG. 3) in the tongue portion 120. Note that the other section of the grounding metal plate 400 is formed with a plurality of grounding recesses 410 (see FIG. 3) respectively receiving the engaging blocks 111 of the main portion 110 of the insulated body 100 after assembly.

The metal cover member 500 is mounted securely above the tongue portion 120 of the insulated body 100 and is further integrally formed with the grounding metal plate 400.

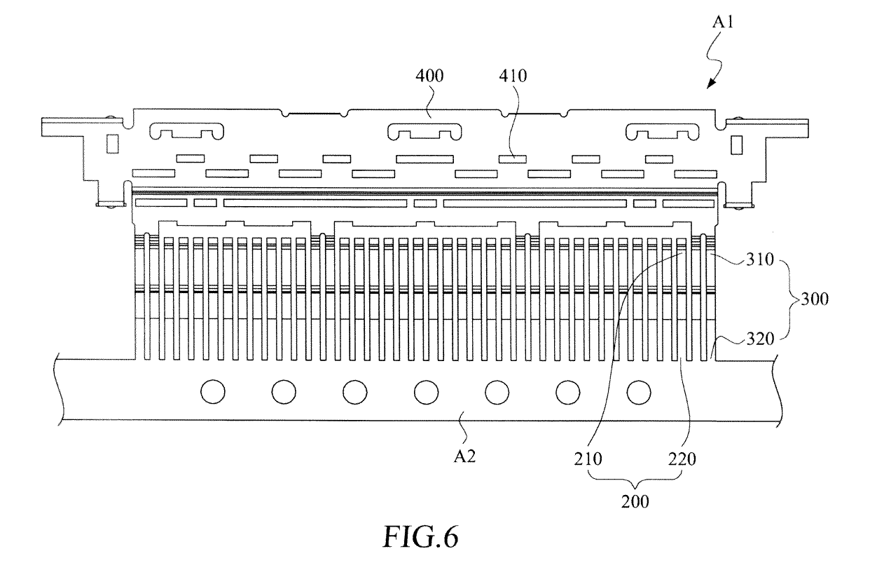

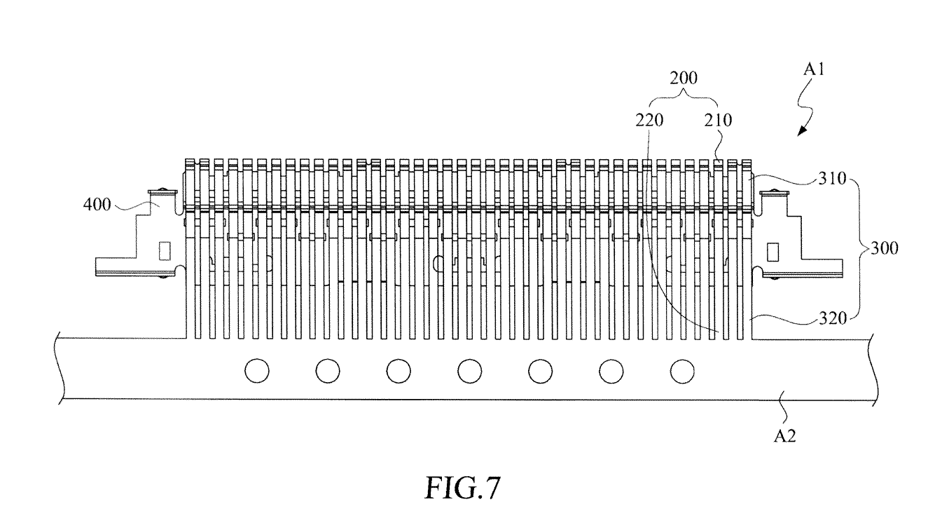

FIGS. 6 and 7 show a top planar view of a relatively large metal plate (A1) from which the conduction terminals 200, the grounding terminals 300 and the grounding metal plate 400 are fabricated during manufacturing process in order to form the electrical connector of the present invention. During the manufacturing process, the relatively large metal plate (A1) is punched, bent and cut out in such a manner to form the conduction terminals 200, the grounding terminals 300 and the grounding metal plate 400, as best illustrated in FIG. 6, so that a connection part (A2) of the metal plate (A1) is integrally formed with the conduction terminals 200, the grounding terminals 300 and the grounding metal plate 400 at this time.

Afterward, the large metal plate (A1) is bent downward from an adjoining position of the grounding terminals 300 and the grounding metal plate 400, the adjoining position is proximate to the connection sections 310 of the grounding terminals 300, thereby obtaining a semi-finished electrical connector of the present invention, as best shown in FIG. 7.

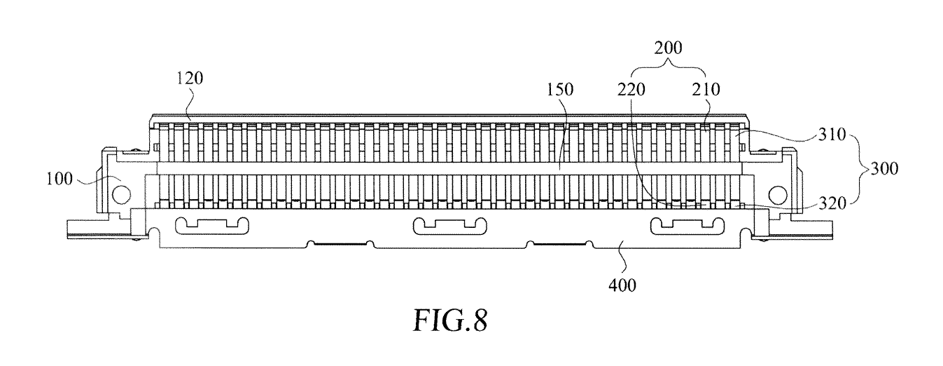

Finally, the large metal plate (A1) is placed within a mold (not shown in the drawings) and the insert-molding process is conducted by injecting plastic material into the mold in order to form the insulated body 100. After removal of the mold from the insulated body 100, the connection part (A2) is cut off from a position proximate to the termination sections 220, 320 of the conduction and grounding terminals 200, 300. Hence the conduction terminals 200, the grounding terminals 300 and the grounding metal plate 400 are mounted on the insulated body 100, as best shown in FIG. 8.

As described above, the grounding terminals 300 and the grounding metal plate 400 are integrally formed with each other to define a terminal grounding structure for grounding purpose such that the electrical connector of the present invention is said to possess the grounding terminal structure and therefore does not need other structure for electrically connected to the grounding terminals 300 and the grounding metal plate 400 since the latter two are integrally formed with each other. In other words, there is no need to conduct the soldering process and hence economizing the labor time. In addition, the problem of accidentally touching an adjacent terminal during the soldering process and hence leading a short circuit as encountered in the prior art manufacturing can be avoided. Furthermore, since insert-molding process is used in the present invention for mounting the insulated body 100 relative to the conduction terminals 200 and the grounding terminals 300, the latter two are stably and securely fixed on to the insulated body 100 after production. Moreover, the need of holding the entire terminals in alignment firstly into a row during insertion of the terminals into the insulated body in the prior art is also avoided. Hence there is no failure of terminal insertion, and leading to better quality and no discarding of the electrical connector of the present invention.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. An electrical connector comprising:
an insulated body including a holding tongue portion having upper and lower surfaces and a front end thereof;
a conduction terminal disposed on said upper surface of said holding tongue portion and having a contact section;
a grounding terminal disposed on said upper surface of said tongue portion, spaced apart from said conduction terminal and having a connection section; and
a grounding metal plate disposed below and attached to said lower surface of said tongue portion, said grounding metal plate being integrally formed with said connection section of said grounding terminal proximate to said front end of said holding tongue portion; whereby said conduction terminal, said grounding terminal, and said grounding metal plate forms a grounding terminal structure for grounding said electrical connector;
wherein, said contact section of said conduction terminal is also located proximate to said front end of said holding tongue portion.

2. The electrical connector according to claim 1, wherein said conduction terminal and said grounding terminal are arranged on said holding tongue portion in a parallel manner relative to each other.

3. The electrical connector according to claim 2, wherein said contact section of said conduction terminal and said connection section of said grounding terminal are flushed with each other along a predetermined direction with said grounding metal plate extending along said predetermined direction.

4. The electrical connector according to claim 2 further comprising a plurality of said conduction terminals and a plurality of said grounding terminals, which are disposed alternately relative to said conduction terminals along a predetermined direction with said grounding metal plate extending along said predetermined direction.

5. The electrical connector according to claim 2, wherein each of said conduction terminals further has a termination section opposite to said contact section, each of said grounding terminals further having a termination section opposite to said connection section.

6. The electrical connector according to claim 2, wherein said conduction terminal and said grounding terminal may have the same structure.

7. The electrical connector according to claim 1, further comprising a metal cover member mounted securely on said holding tongue portion of said insulated body and integrally connected to with said grounding metal plate.
